(19) United States
(12) Patent Application Publication
(10) Pub. No.: US 2023/0130206 A1
(43) Pub. Date: Apr. 27, 2023

(54) ACHIEVING THE BEST COMPLIANCE RESULTS WHILE MINIMIZING SENSITIVE DATA PLACEMENT POLICY VIOLATIONS WITH A SMART SCHEDULER

(71) Applicant: International Business Machines Corporation, Armonk, NY (US)

(72) Inventors: Jojo Joseph, Bengaluru (IN); Sathis R Marudanayagam, Bengaluru (IN); Paul Baby, Bangalore (IN); Afizullah Shaik, Yerraguntla (IN)

(21) Appl. No.: 17/451,837

(22) Filed: Oct. 22, 2021

(51) Int. Cl. G06F 21/62; G06F 21/64

(52) U.S. Cl. CPC G06F 21/6245; G06F 21/64; G06F 21/6281

(57) ABSTRACT

Ensuring that there is a consistent and reliable manner for detecting and remedying potential policy violations from enterprise data sources by automating the scheduling of compliance checks on these enterprise data sources. These enterprise data sources include documents that are used by an enterprise that must be in compliance with a particular regulation.

### BACKGROUND

The present invention relates generally to the field of regulatory compliance, and more particularly to the use of automated enterprise related solutions to ensure that large enterprises can remain compliant with the relevant regulations.

### SUMMARY

According to an aspect of the present invention, there is a method, computer program product and/or system that performs the following operations (not necessarily in the following order): (i) defining a sensitive data placement policy for each data source; (ii) computing a first priority score, with the priority score defining a priority level of a data source to be scanned; (iii) scheduling a data scan for the data source based, at least in part, upon the computed first priority score; (iv) identifying a set of policy violations while performing the scheduled data scan; and (v) performing a remediation action to remedy the set of policy violations.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a diagram showing information that is helpful in understanding embodiments of the present invention.

### DETAILED DESCRIPTION

Some embodiments of the present invention are directed towards ensuring that there is a consistent and reliable manner for detecting and remedying potential policy violations from enterprise data sources by automating the scheduling of compliance checks on these enterprise data sources. These enterprise data sources include documents that are used by an enterprise that must be in compliance with a particular regulation.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

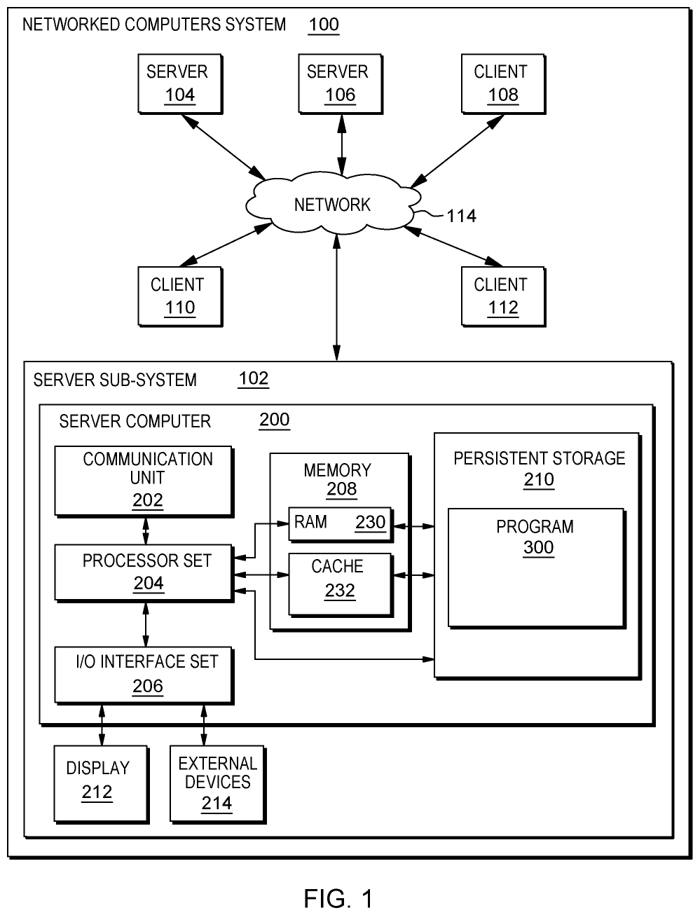

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

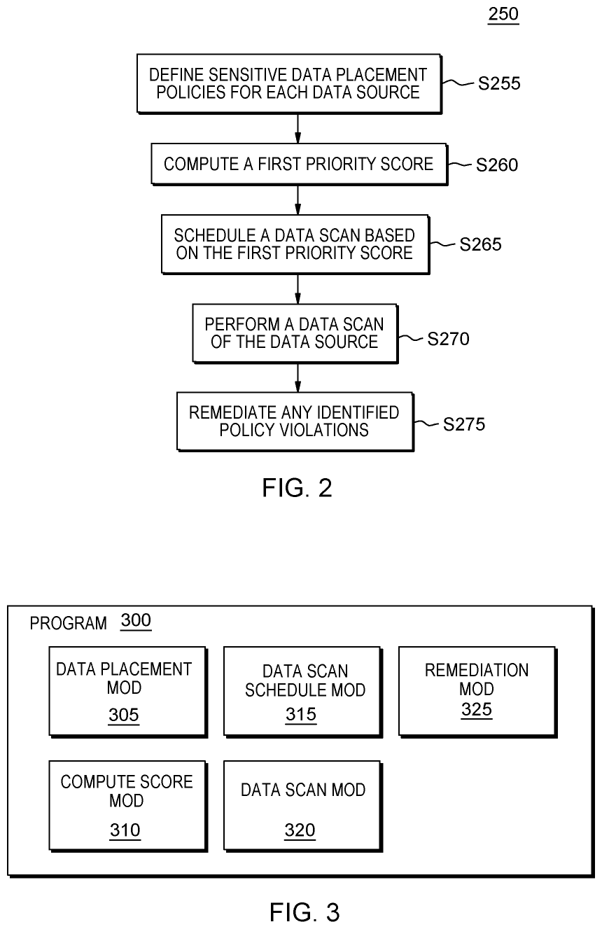

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where data placement module (“mod”) 305 initially defines a sensitive data placement policy for each data source. This policy defines what kind of information is allowed or not allowed on that data source. This operation is described in greater detail in Sub-Section III, below.

Processing proceeds to operation S260, where compute score mod 310 computes a scanning priority score. In some embodiments of the present invention, the scanning priority score value indicates the priority in which certain documents that are received (from the data sources, discussed above in connection with operation S255) should be scanned. In some embodiments, the scanning priority score value is indicative of the document type relevance. For example, if a given company (Company A) is operating in the healthcare industry, it is more pertinent and urgent to determine whether any given documents contain healthcare related regulatory violations. Therefore, for Company A, documents that primarily contain information implicating healthcare related regulations are given a higher scanning priority score. Additionally, the methodology to compute the scanning priority score is described in greater detail in Sub-Section III, below.

Processing proceeds to operation S265, where data scan schedule mod 315 schedules a data scan based on the computed scanning priority score (discussed in connection with operation S260, above). In some embodiments, data scan schedule mod 315 automatically determines when a given data source needs to be scanned. However, alternatively, a user can manually override the scanning schedule that is determined by data scan schedule mod 315 in instances where mod 315 is managing a relatively smaller set of documents.

Processing proceeds to operation S270, where data scan mod 320 performs a data scan of the data source in order to identify any potential policy violations. In some embodiments, data scan mod 320 performs a general data scan of the documents to identify policy violations based upon every relevant regulation that an enterprise entity (such as Company A) typically encounters. Alternatively, data scan mod 320 performs a targeted scan to identify potential policy violations that relate to a single specified regulation (or specified regulation type). For example, if Company A is a healthcare enterprise, then data scan mod 320 would run (depending upon the need), the following: (i) a general scan that identifies all potential policy violations that are in conflict with all regulations that affect Company A's core operating interests/ability; and/or (ii) a targeted, specific scan that identifies only regulations that primarily implicate potential healthcare regulation related violations.

Processing finally proceeds to operation S275, where remediation mod 325 performs remediation actions on any policy violations that are found in the data source (as discussed in connection with operation S270, above).

### III. Further Comments and/or Embodiments

Large enterprises that typically operate in highly regulated environments typically need to run compliance projects in order to certify that they are in compliance with the rules and regulations issued by a particular government agency and/or corporate governance polices created by the organization. Some regulations like GDPR, CCPA, etc. are applicable irrespective of the industry, whereas other regulations such as HIPAA are applicable only to certain industries. The key thing is, creating governance policies, adhering to these policies and auditing the adherence on a continuous basis is important for enterprises.

Some embodiments of the present invention recognize the following facts, potential problems and/or potential areas for improvement with respect to the current state of the art: (i) all the data sources are treated equally irrespective of the flow of the new/updated content in a specific period; (ii) scheduler picks up the data source in a pre-defined order to run the compliance check job instead of data sources, which require more attention and remediation; (iii) compliance checks are running the predefined order and does not identify on its own to pick up the right data source at any given point of time—this requires user intervention; and (iv) when running against time and resources, running compliance jobs on data sources that don't require immediate attention would affect the organisation's compliance readiness.

Some embodiments of the present invention provide for scheduling of compliance check determined by score, which in turn is computed based on the found hotspots, remediation and data source changes and not by the user configuration set.

Some embodiments of the present invention provide a way to identify the largest number of policy violations and remediating them, thus minimizing the risk of policy violation within the enterprise. This is achieved using a smart scheduler which will prioritize periodic scans on enterprise data sources based on several factors such as how active the data source is, and other factors described below (as mentioned in paragraph 43, below), instead of the pre-defined scheduler base. The identification of active data source can happen in various ways such as rates of new/updated content in a given time frame (hour/day/week/month) etc. This would eventually make the organisations to be free from “pre-defined scheduled compliance scans.”

Additionally, this will help enterprises to focus on the right data sources to reduce the risk of sensitive data leaks as well as achieve maximum compliance in any given point of time.

Some embodiments of the present invention provide a novel system and method to identify the data source, which requires immediate attention with the respect to the compliance perspective, automatically based on the various parameters, that would affect the data source's compliance readiness.

Some embodiments of the present invention compute a priority score based, at least in part, upon the following parameters: (i) recent changes in the respective data source (measured by the number of new documents added or number of documents updated after the last assessment); (ii) identified hotspots from the past; (iii) remediated hotspots from the past; (iv) user defined priority of this data source; and (v) the number of days since the last scan run.

As used herein in this document, the term “hotspot” refers to an area (such as a folder or a user's email inbox) where a greater number of policy violations are found compared to other areas on that same data source.

Some embodiments of the present invention provide for a method, with the method including the following operations (and not necessarily in the following order): (i) create a connection with data source with the required credentials; (ii) ensure that the required logic for detecting policy violations with identifiers are applied on the data source and run once; (iii) input variables used for deciding the priority of this data source relative to other data sources, such as: (a) record the user's priority to run the compliance check job—say weight w1 which is a number between 1 and 100, (b) hotspots identified based on previous assessments, say the weight w2, (c) collect remediation details as provided by the data steward or collected from the data source if available, say the weight w3. If the data source is completely remediated, then gets a weight of 100, if not a proportional weight between 0 and 100, (d) store the “Last scan run date” to calculate number of days, say the weight w4, (e) number of documents/files added from the last assessment, say the weight w5, (f) number of documents/files modified after the last assessment, say the weight w6, and (g) projected number of violations in this data source based on the history of violations detected, say the weight w7; (iv) provide weight for each variable to compute the priority score; (v) compute score for each data source, see the details below; (vi) based on the score, prioritize the data sources for scanning; (vii) run the scan based on the priority; (viii) remediate (such as deleting, redacting or marking as false positive) the data source; and (ix) continue the same from operation (iii) to automatically identify the data source for the next scan.

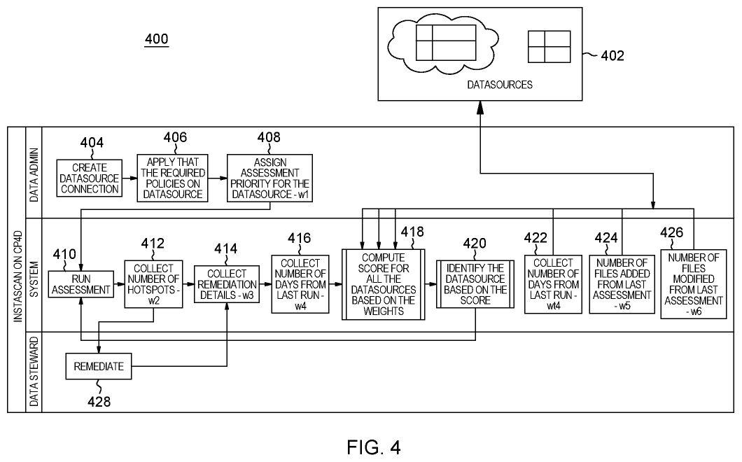

In some embodiments, an exemplary method of computing the priority score is described here. Since we already know the projected number of violations on this data source, we can compute the probability value such that, selecting a random document from the overall corpus of documents in all the data sources, results in picking up a non-compliant document from this data source. This probability can be normalized to a value between 0 and 100, and then a linear combination with w1 (priority assigned by the data steward), w3 (remediation score provided by the data steward), to compute the priority score for this data source. The coefficient in this computation will be stored and then re-evaluated after the assessment. These coefficients will be saved for future use. This method is generally shown in diagram 400 of FIG. 4.

Some embodiments of the present invention provide a method and system to best achieve compliance results with the least amount of policy violations. This method can include the following operations (not necessarily in the following order): (i) define sensitive data placement policies for each data source; (ii) compute priority of scanning, schedule scanning and remediate data sources as defined below; (iii) collect inputs from a data steward such as: (a) priority of the data source for achieving compliance, and (b) remediation score for manual remediation; (iv) collect details including: (a) volume of new or modified content on that data source, (b) amount of violations and hotspots found on that data source in the past, (c) what percentage of violations where remediated (auto-remediation), and (d) time since the last scan and remediation done on a data source; (v) compute a score that defines the priority of a data source using various parameters listed above; (vi) schedule a scan using the score above; (vii) a scheduler that scans the data sources according to the above schedule and identifying policy violations; (viii) a remediation mechanism (move, delete, mask) to address policy violations identified above; and (ix) minimizing the policy violations across all data sources following the above.

These operations are generally shown by diagram 400 of FIG. 4. More specifically, diagram 400 shows data sources 402, and operations for a data administrator. These operations include: create a data source connection 404, apply the required policies on the data source 406, and assign assessment priority for the data source 408.

Diagram 400 additionally shows operations for the system, including the following: run assessment 410, collect number of hotspots 412, collect remediation details 414, collect number of days from the last run 416, compute score for all of the data sources based on the assigned weights 418, identify the data source based on the computed score 420, collect numbers of days from the last run 422, number of files added from the last assessment 424, and number of files modified from the last assessment 426.

Diagram 400 finally shows operations for the data steward, which includes performing remediation actions 428 after collecting the number of hotspots (from operation 412).

In some embodiments of the present invention, examples of policies that a data source must comply with include the following: (i) credit card numbers cannot be shown and/or otherwise be made accessible in an email; (ii) a user's social security number (SSN) cannot be shown and/or otherwise be made accessible in any document that is stored on the content server; and (iii) a user's medical history record cannot be attached to any emails.

In some embodiments of the present invention, examples of policy violations (for the policies mentioned above) include the following: (i) a credit card number is found in an email sent by an employee; (ii) a user's SSN is found in a document that is uploaded to the content server; and (iii) a user's medical history is found in an email attachment.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
defining a sensitive data placement policy for each data source;
computing a first priority score, with the priority score defining a priority level of a data source to be scanned;
scheduling a data scan for the data source based, at least in part, upon the computed first priority score;
identifying a set of policy violations while performing the scheduled data scan; and
performing a remediation action to remedy the set of policy violations.

2. The CIM of claim 1 wherein the set of policy violations includes a data source having information indicative of personal identifiable information (PII).

3. The CIM of claim 1 wherein the set of policy violations includes a data source having information indicative of medical history.

4. The CIM of claim 1 wherein the priority score is computed based, at least in part, upon a stated priority of a first user to run a compliance check on the data source.

5. The CIM of claim 1 wherein the priority score is based, at least in part, upon a projected number of policy violations for the data source, with the projection being based upon a history of violations being detected for the data source type.

6. The CIM of claim 5 wherein the projected number of policy violations for the data source is based, at least in part, upon a history of violations detected for the data source type.

7. A computer program product (CPP) comprising:
a machine readable storage device; and
computer code stored on the machine readable storage device, with the computer code including instructions and data for causing a processor(s) set to perform operations including the following:
defining a sensitive data placement policy for each data source,
computing a first priority score, with the priority score defining a priority level of a data source to be scanned,
scheduling a data scan for the data source based, at least in part, upon the computed first priority score,
identifying a set of policy violations while performing the scheduled data scan, and
performing a remediation action to remedy the set of policy violations.

8. The CPP of claim 7 wherein the set of policy violations includes a data source having information indicative of personal identifiable information (PII).

9. The CPP of claim 7 wherein the set of policy violations includes a data source having information indicative of a user's medical history.

10. The CPP of claim 7 wherein the priority score is computed based, at least in part, upon a stated priority of a first user to run a compliance check on the data source.

11. The CPP of claim 7 wherein the priority score is based, at least in part, upon a projected number of policy violations for the data source, with the projection being based upon a history of violations being detected for the data source type.

12. The CPP of claim 7 wherein the projected number of policy violations for the data source is based, at least in part, upon a history of violations detected for the data source type.

13. A computer system (CS) comprising:
a processor(s) set;
a machine readable storage device; and
computer code stored on the machine readable storage device, with the computer code including instructions and data for causing the processor(s) set to perform operations including the following:
defining a sensitive data placement policy for each data source,
computing a first priority score, with the priority score defining a priority level of a data source to be scanned,
scheduling a data scan for the data source based, at least in part, upon the computed first priority score,
identifying a set of policy violations while performing the scheduled data scan, and
performing a remediation action to remedy the set of policy violations.

14. The CS of claim 13 wherein the set of policy violations includes a data source having information indicative of personal identifiable information (PII).

15. The CS of claim 13 wherein the set of policy violations includes a data source having information indicative of a user's medical history.

16. The CS of claim 13 wherein the priority score is computed based, at least in part, upon a stated priority of a first user to run a compliance check on the data source.

17. The CS of claim 13 wherein the priority score is based, at least in part, upon a projected number of policy violations for the data source, with the projection being based upon a history of violations being detected for the data source type.

18. The CS of claim 17 wherein the projected number of policy violations for the data source is based, at least in part, upon a history of violations detected for the data source type.
